(19) United States
(12) Patent Application Publication
(10) Pub. No.: US 2026/0185191 A1
(43) Pub. Date: Jul. 2, 2026

(54) Stress Corrosion Cracking Resistant, High Strength, Weldable Aluminum Alloy

(71) Applicant: ATI, Inc., Nicholasville, KY (US)

(72) Inventor: Alex Cho, Nicholasville, KY (US)

(21) Appl. No.: 18/725,526

(22) PCT Filed: Oct. 2, 2023
(86) PCT No.: PCT/US2023/034287

§ 371 Date: Jun. 28, 2024

(51) Int. Cl. C22C 21/10; B23K 35/02; B23K 35/28

(52) U.S. Cl. CPC C22C 21/10; B23K 35/0261; B23K 35/288

(57) ABSTRACT

A new 7xxx aluminum alloy provides a unique combination of quantifiable physical characteristics. The alloy may be generally described as a corrosion resistant aluminum-zinc-magnesium-titanium-boron-cerium based alloy that is copper free or only includes slight amounts of copper as an impurity.

### TECHNICAL FIELD

This document relates generally to aluminum-zinc-magnesium-titanium-boron-cerium based alloys and products, and more particularly to aluminum-zinc-magnesium-manganese-cerium-chromium-zirconium, -titanium-boron based alloys and products particularly suitable as wrought product for armored military vehicles and other structural applications requiring very high strength and ductility and excellent weldability with high post-weld mechanical properties and acceptable stress corrosion cracking resistance.

### BACKGROUND

Aluminum alloys containing zinc and magnesium are known in the art. However, most of these existing alloys are non-weldable alloys or if weldable, they are low strength alloys. For purposes of this document, “low strength alloys” refers to aluminum alloys having a tensile yield strength of less than 60 ksi.

Fisher et al. in U.S. Pat. No. 10,301,710 teaches Al—Zn—Mg—Cu alloys which are not sensitive to quench. Trenda Gunther et. al in. U.S. Pat. No. 8,491,733 teaches Al—Zn—Mg—Cu—Sc alloys for high strength alloys. Senkov et al. in U.S. Pat. No. 7,060,139 teaches Al—Zn—Sc—Mg—Cu—Zr—Si alloy high strength material. Higashi et. al in U.S. Pat. No. 4,713,216 teaches Al—Zn—Mg—Cu—Sc alloys containing rare earth elements to make stress corrosion resistant high strength aluminum alloys. Benedictus et al. in U.S. Pat. No. 10,472,707 teaches Al—Zn—Mg—Cu alloys containing Sc and other rare earth elements to make low internal stress bearing high strength material. Mann et al. in U.S. Patent Application 2020/0087756 teaches Al—Zn—Mg—Ca—Fe—Ni—Ti—Ce—Sc alloys for high strength cast product. Wang et al. in U.S. Patent Application 2012/000057841 teaches Al—Si—Cu—Ni—Fe—Zn—Mg alloy with rare earth elements for high strength cast product. Olando Rio et al. in U.S. Patent Application 2019/00885431 teaches Al—Zn—Mg—Cu alloys with rare earth elements for intergranular corrosion resistant high strength material. Ronan Diff et. al in U.S. patent Application 2006/0016523 A1 teaches Al—Zn—Mg—Mn—Cr—Zr type alloy can be weldable but low strength and applicable only thin sheet gauge (3 mm-12 mm) material. Therefore, all of existing 7xxx alloys are non-weldable alloys or if weldable, they are low strength alloys.

This document relates to a new and improved weldable and stress corrosion resistant, high strength aluminum alloy that represents a significant advance in the art.

### SUMMARY

An object of the present invention is to provide a stress corrosion resistant, weldable by TIG or MIG welding techniques, high strength, high ductility 7xxx aluminum alloy. For purposes of this document, a “high strength” aluminum alloy refers to an alloy having a tensile yield strength of greater than 60 ksi.

In accordance with the purposes and benefits described herein, a new and improved 7xxx aluminum alloy comprises or consists of: (a) 4.0-8.0 wt. % zinc, (b) 1.5-3.0 wt. % magnesium, (c) 0.01-0.8 wt. % of cerium, (d) 0.01-0.25 wt. % of titanium, (e) 0.01-0.11 wt. % of boron as form of titaninum diboride (TiB2) or commercial name of Titaniumdiboride 3.1, or Titaniumdiboride 5.1, 0.01-0.8 wt. % of a material selected from a group consisting of a rare earth element, lanthanum, neodymium, samarium, mish metal or combinations thereof, (f) a dispersoid forming element selected from a group consisting of up to 1.2 wt. % manganese, up to 1.0 wt. % of zirconium, up to 1.0 wt. % of chromium and combinations thereof, (g) up to 1.0 wt. % impurities and (h) remainder as aluminum.

In at least one of the many possible embodiments of the 7xxx aluminum alloy, the impurities include up to 0.5 wt. % iron. In at least one of the many possible embodiments of the 7xxx aluminum alloy, the impurities include up to 0.5 wt. % silicon. In at least one of the many possible embodiments of the 7xxx aluminum alloy, the impurities include less than 0.3 wt. % copper. In at least one of the many possible embodiments of the 7xxx aluminum alloy, the impurities include less than 0.1 wt. % copper. In at least one of the many possible embodiments of the 7xxx aluminum alloy, the 7xxx aluminum alloy is copper free.

In at least one of the many possible embodiments of the 7xxx aluminum alloy, the 7xxx aluminum alloy includes less than 0.5 wt. % of scandium as impurities. In at least one of the many possible embodiments of the 7xxx aluminum alloy, the 7xxx aluminum alloy includes less than 0.3 wt. % of scandium as impurities. In at least one of the many possible embodiments of the 7xxx aluminum alloy, the 7xxx aluminum alloy is scandium free.

In at least one of the many possible embodiments of the 7xxx aluminum alloy, the 7xxx aluminum alloy includes less than 0.8 wt. % of nickel as impurities. In at least one of the many possible embodiments of the 7xxx aluminum alloy, the 7xxx aluminum alloy includes less than 0.3 wt. % of nickel as impurities. In at least one of the many possible embodiments of the 7xxx aluminum alloy, the 7xxx aluminum alloy is nickel free.

In at least one of the many possible embodiments of the 7xxx aluminum alloy, the 7xxx aluminum alloy includes less than 0.25 wt. % of vanadium as impurities. In at least one of the many possible embodiments of the 7xxx aluminum alloy, the 7xxx aluminum alloy includes less than 0.15 wt. % of vanadium as impurities. In at least one of the many possible embodiments of the 7xxx aluminum alloy, the 7xxx aluminum alloy is vanadium free.

In at least one of the many possible embodiments of the 7xxx aluminum alloy, the 7xxx aluminum alloy comprises or consists of: (a) 5.0-7.5 wt. % zinc, (b) 1.5-2.6 wt. % magnesium, (c) 0.01-1.0 wt. % manganese, (d) 0.01-0.25 wt. % of titanium, (e) 0.01-0.11 wt. % of boron as form of titanium diboride, or commercial name as Titanium diboride 3.1 or Titanium diboride 5.1 (f) 0.01-0.25 wt. % of a material selected from a group consisting of a rare earth element, cerium, misch metal, lanthanum, samarium, neodymium or combinations thereof, (g) up to 0.3 wt. % zirconium and (h) remainder aluminum with 1.0% or less impurities.

That 7xxx aluminum alloy may also include 0.1-1.0 wt. % chromium. That 7xxx aluminum alloy may include 0.1-0.8 wt. % manganese. That 7xxx aluminum alloy may include less than 0.3 wt. % copper, less than 0.1 wt. % copper or even be copper free. That 7xxx aluminum allow may include less than 0.8 wt. % scandium, less than 0.3 wt. % scandium or even be scandium free. That 7xxx aluminum alloy may include less than 0.8 wt. % nickel, less than 0.3 wt. % nickel or even be nickel free. That 7xxx aluminum alloy may include less than 0.25 wt. % vanadium, less than 0.15 wt. % vanadium or even be vanadium free.

That 7xxx aluminum alloy may have the following: (a) a stress corrosion cracking resistance of at least 26 ksi for 20 days per G47 (as of Dec. 1, 2020), (b) an ultimate strength of at least 65 ksi, (c) a tensile yield strength of at least 60 ksi (d) an elongation of at least 4% per ASTM B557-15 (as of Dec. 1, 2020), and (e) a post-weld ductility of at least 3.0% elongation tested using 2.54 cm gauge length tensile specimen across weldment on 60 degree beveled 1.27 cm plates as AWS (American Welding Society) recommended.

In accordance with yet another aspect, a composition of matter is provided. That composition of matter comprises or consists of an aluminum, zinc and magnesium, titanium, boron, cerium alloy system having a post weld ductility of at least 3% elongation.

That composition of matter may also have a stress corrosion cracking resistance of at least 26 ksi for 20 days per G47. That composition of matter may also have an ultimate strength of at least 65 ksi. That composition of matter may also have a tensile yield strength of at least 60 ksi. That composition of matter may also have an elongation of at least 4% of tensile test results per ASTM B557-15.

In the following description, there are shown and described several preferred embodiments of the 7xxx aluminum alloy and the composition of matter. As it should be realized, the 7xxx aluminum alloy and the composition of matter are capable of other, different embodiments and their several details are capable of modification in various, obvious aspects all without departing from the 7xxx aluminum alloy and the composition of matter as set forth and described in the following claims. Accordingly, the descriptions should be regarded as illustrative in nature and not as restrictive.

### DETAILED DESCRIPTION

The new and improved 7xxx alloy and composition of matter that is the subject matter of this document provides a unique combination of quantifiable physical properties including very high strength and ductility and acceptable stress corrosion resistance as well as excellent weldability with high post-weld mechanical properties. As a result, the new 7xxx aluminum alloy and composition of matter is particularly suited as wrought product for armored military vehicles and other structural applications such as sporting goods and bicycles etc.

The new and improved 7xxx aluminum alloy comprises; (a) 4.0-8.0 wt. % zinc, (b) 1.5-3.0 wt. % magnesium, (c) 0.01-0.8 wt. % of a material selected from a group consisting of a rare earth element, cerium, misch metal or combinations thereof, (d) a dispersoid forming element selected from a group consisting of up to 1.2 wt. % manganese, between 0.01-0.25 wt. % titanium, 0.01-0.11 wt. % of boron, up to 1.0 wt. % of zirconium, up to 1.0 wt. % of chromium, and combinations thereof, (e) up to 1.0 wt. % impurities and (f) remainder as aluminum. For purposes of this document, “misch metal” refers to an alloy containing cerium (Ce), lanthanum (La), neodymium (Nd) and other rare earth elements. In one particularly useful embodiment of the new improved 7xxx aluminum alloy, the rare earth element is selected from a group of elements consisting of yttrium (Y), praseodymium (Pr), promethium (Pm), gadolinium (Gd), terbium (Tb), dysprosium (Dy), holmium (Ho), erbium (Er), thulium (Tm), ytterbium (Yb), lutetium (Lu) and combinations thereof.

The impurities may include up to 0.5 wt. % iron and/or up to 0.5 wt. % silicon. In one or more embodiments, the 7xxx aluminum alloy is copper free. In other embodiments, the 7xxx aluminum alloy includes less than 0.1 wt. % copper as an impurity. In other embodiments, the 7xxx aluminum alloy includes less than 0.3 wt. % copper as an impurity.

In one or more embodiments, the 7xxx aluminum alloy is scandium free. In other embodiments, the 7xxx aluminum alloy includes less than 0.3 wt. % scandium. In other embodiments, the 7xxx aluminum alloy includes less than 0.8 wt. % scandium.

In one or more embodiments, the 7xxx aluminum alloy is nickel free. In other embodiments, the 7xxx aluminum alloy includes less than 0.3 wt. % nickel. In other embodiments, the 7xxx alloy includes less than 0.8 wt. % nickel.

In one or more embodiments, the 7xxx aluminum alloy is vanadium free. In other embodiments, the 7xxx aluminum alloy includes less than 0.15 wt. % vanadium. In other embodiments, the 7xxx aluminum alloy includes less than 0.25 wt. % vanadium.

In some embodiments, the 7xxx aluminum alloy includes 0.1-0.5 wt. % manganese. In some embodiments, the 7xxx aluminum alloy includes between 0.1-1.0 wt. % nickel. In some embodiments, the 7xxx aluminum alloy includes between 0.1-1.0 wt. % chromium. In some embodiments, the 7xxx aluminum alloy includes both nickel and chromium in these amounts. In some embodiments, the 7xxx aluminum alloy includes 0.1-0.8 wt. % scandium, 0.1-1.0 wt. % nickel and 0.1-1.0 wt. % chromium. Any of these embodiments may be copper free or contain less than 0.3 wt. % copper as an impurity or less than 0.1 wt. % copper as an impurity.

Any of these embodiments may be scandium free or contain less than 0.8 wt. % scandium as an impurity or less than 0.3 wt. % scandium as an impurity. Any of these embodiments may be nickel free or contain less than 0.8 wt. % nickel as an impurity or less than 0.3 wt. % nickel as an impurity. Any of these embodiments may be vanadium free or contain less than 0.25 wt. % vanadium as an impurity or less than 0.15 wt. % vanadium as an impurity.

The 7xxx aluminum alloy may be described as consisting of (a) 5.0-7.5 wt. % zinc, (b) 1.5-2.6 wt. % magnesium, (c) 0.01-1.0 wt. % manganese, (d) 0.01-0.8 wt. % of a material selected from a group consisting of a rare earth element, cerium, misch metal or combinations thereof, (e) 0.01-0.25 wt. % titanium, (f) up to 0.11 wt. % boron as a form of TiB2 (intermetallic particle of TiB2), (g) up to 0.3 wt. % zirconium and (h) the remainder aluminum with 1.0 wt. % or less in impurities. In one particularly useful embodiment of the new improved 7xxx aluminum alloy, the rare earth element is selected from a group of elements consisting of yttrium (Y), praseodymium (Pr), promethium (Pm), gadolinium (Gd), terbium (Tb), dysprosium (Dy), holmium (Ho), erbium (Er), thulium (Tm), ytterbium (Yb), lutetium (Lu) and combinations thereof.

In one possible embodiment, the 7xxx aluminum alloy includes up to 0.5 wt. % scandium and up to 0.2 wt. % zirconium.

That 7xxx aluminum alloy exhibits a post weld ductility of at least 3.0% elongation per ASTM B557-15. The 7xxx aluminum alloy exhibits a stress corrosion cracking resistance of at least 26 ksi for 20 days per G47 as of Dec. 1, 2020. The 7xxx aluminum alloy exhibits an ultimate strength of at least 65 ksi. The 7xxx aluminum alloy exhibits a tensile yield strength of at least 60 ksi. The 7xxx aluminum alloy exhibits an elongation of at least 4%. Further, it should be appreciated that the 7xxx aluminum alloy exhibits a combination of all five of these physical characteristics or properties. This unique combination of physical characteristics or properties make the new 7xxx aluminum alloy particularly useful for armored military vehicle applications as well as for other applications requiring very high strength and ductility and excellent weldability with high post-weld mechanical properties and acceptable stress corrosion resistance.

Consistent with the above description, a composition of matter is provided. That composition of matter comprises or consists of an aluminum-zinc-magnesium-titanium-boron-cerium based alloy system having a post weld ductility of at least 3% elongation per ASTM B557-15.

That composition of matter may also have at least one or more of the following properties: (a) a stress corrosion cracking resistance of at least 26 ksi for 20 days per G47, (b) an ultimate strength of at least 65 ksi, (c) a tensile yield strength of at least 60 ksi and (d) an elongation of at least 4% per ASTM B557-15.

The 7xxx aluminum alloy or composition of matter may be cast into billets or ingots. Those billets or ingots may then be subject to conventional transformation techniques. For example, the billets or ingots may be subject to a homogenization stage at temperatures between 426.7° C. (800° F.) and 493.3° C. (920° F.), followed by hot rolling, forging, extruding or wire drawing, then a solution heat treatment at temperatures between 426.7° C. (800° F.) and 498.8° C. (930° F.) followed by quenching and stress relieving operations. Finally, an aging treatment, preferably by two step age, may be conducted in order to obtain a product in temper T6

The 7xxx aluminum alloy or composition of matter made may be used to produce plate, sheet, extrusion and forgings that exhibit the unique combination of material properties outlined above. The 7xxx aluminum alloy or composition of matter may include from 0.01 to 0.11 wt % boron, from 0.2 to 0.11 wt % boron, from 0.25-0.11 wt % boron.

A new and improved welding wire is also provided. That welding wire has the following composition:
3.0-4.5 wt. % zinc,
1.5-5.0 wt. % magnesium;
0.01-0.8 wt. % of a material selected from a group consisting of (a) a rare earth element, cerium, misch metal, lanthanum, neodymium, samarium, or combinations thereof, (b) a dispersoid forming element selected from a group consisting of up to 1.2 wt. % manganese, between 0.01-0.25 wt. % titanium, between 0.01-0.2 wt. % boron, up to 1.0 wt. % of zirconium, up to 1.0 wt. % of chromium, and combinations thereof;
up to 1 wt. % of impurities including less than 0.1 wt. % copper; and
remainder as aluminum.

### Experimental Results

Twelve (12) 30 lbs. rectangular ingots of high strength 7xxx alloys were cast. Those ingots were then subject to conventional transformation techniques, comprising of a homogenization stage, followed by hot rolling, a solution heat treatment followed by quenching and stress relieving operations. Finally an aging treatment was conducted in order to obtain a product in temper T651 having a thickness of 3.81 cm to conduct mechanical property testing. Welding tests were conducted 1.27 cm plate of T651 Temper.

The chemistries of the eleven ingots are presented in the following Table:

### 1. Chemistry (all in Wt. %)

| | | | | | | | | | | misch | |
|---|---|---|---|---|---|---|---|---|---|---|---|
| alloy | Cu | Mg | Mn | Ti | Zr | Zn | Cr | Ce | Ni | metal | B |
| AA7085 | 1.6 | 1.8 | 0 | 0.02 | 0.12 | 7.5 | 0 | 0 | 0 | 0 | 0 |
| AA7050 | 2 | 2.2 | 0 | 0.02 | 0.08 | 6.3 | 0 | 0 | 0 | 0 | 0 |
| alloy PA1 | 0.5 | 2.2 | 0 | 0.08 | 0.08 | 5.9 | 0 | 0 | 0 | 0 | 0.02 |
| alloy PA2 | 0.1 | 2.3 | 0.4 | 0.1 | 0 | 6 | 0.25 | 0.1 | 0.3 | 0 | 0.03 |
| alloy PA3 | 0 | 2.2 | 0.4 | 0.11 | 0.1 | 6.1 | 0.35 | 0.2 | 0 | 0 | 0.04 |
| alloy PA4 | 0 | 2.2 | 0.35 | 0.08 | 0.1 | 6.3 | 0 | 0.1 | 0.1 | 0 | 0.02 |
| alloy PA5 | 0 | 2.2 | 0.5 | 0.1 | 0 | 6.4 | 0.13 | 0 | 0 | 0.15 | 0.03 |
| alloy PA6 | 0 | 2.2 | 0.5 | 0.12 | 0 | 6.2 | 0 | 0.1 | 0 | 0 | 0.04 |
| alloy PA7 | 0 | 2.3 | 0.5 | 0.12 | 0.03 | 6.5 | 0 | 0.15 | 0 | 0 | 0.04 |
| alloy PA8 | 0 | 2.5 | 0.5 | 0.12 | 0.11 | 6.5 | 0.075 | 0.075 | 0 | 0 | 0.04 |
| alloy PA9 | 0 | 2.3 | 0.3 | 0.12 | 0.12 | 6.3 | 0.05 | 0.05 | 0 | 0 | 0.04 |

### 2. Weldability Test

The first test was to conduct post-weld tensile tests to evaluate the weldability of the alloys. Weldability tests were conducted on 1.27 cm gauge plate by TIG welding. TIG welding stick alloy, WA1, was developed specifically for 7xxx alloy welding at ATI Inc. as follows:

Chemistry of Welding stick alloy WA1. (all in wt. %)

| Alloy | Cu | Mg | Mn | Ag | Ti | Zr | Zn | B |
|---|---|---|---|---|---|---|---|---|
| WA1 | 0 | 4 | o.5 | 0 | 0.125 | 0 | 2.5 | 0.04 |

Post-weld tensile tests were conducted on 1.27 cm thick alloy plate welded by TIG welding with the welding stick of WA1 alloy. Weldability was tested by conducting duplicate tensile tests across the welded joint by 90 degrees. To avoid the big difference of welded joint width within the specimen of the beveled welded joint, the tensile tests were conducted across weldment on 1.27 cm gauge plate with 60 degree beveled edges with flat tensile test specimens of 0.3175 cm thick by 0.635 cm wide by 2.54 cm gauge length. The 2.54 cm gauge length consisted of 1.27 cm of weldment with 0.635 cm of HAZ (Heat Affected Zone) on both sides.

### 2.A. Weldability of AA7085

Post-weld tensile test results of welded joint of AA7085 are as follows:

| alloy | UTS(ksi) | TYS(ksi) | Elong. (%) |
|---|---|---|---|
| 7085-T6-LT1 | not avail. | not avail, | 0 |
| 7085-T6-LT2 | not avail. | not avail. | 0 |

Post-weld tensile tests of welded joint of AA7085 show zero ductility. Therefore, AA7085 is not weldable.

### 2.B. Weldability of AA7050

Post-weld tensile test results of welded joint of AA7050 are as follows:

| alloy | UTS(ksi) | TYS(ksi) | Elong. (%) |
|---|---|---|---|
| 7050-T6-LT1 | not avail. | not avail. | 0 |
| 7050-T6-LT2 | not avail. | not avail. | 0 |

Post-weld tensile tests of welded joint of AA7050 show zero ductility. Therefore, AA7050 is not weldable.

### 2.C. Weldability of Alloy PA1

In an attempt to improve weldability, reduced Cu containing alloy PAI was tested. Post-weld tensile test results of welded joint of alloy PAI are as follows:

| alloy | UTS(ksi) | TYS(ksi) | Elong. (%) |
|---|---|---|---|
| PA1-LT1 | not avail. | not avail. | 0 |
| PA1-LT2 | not avail. | not avail. | 0 |

Post-weld tensile tests of the welded joint of alloy PAI show zero ductility. Therefore, alloy PAI is not weldable.

### 2.D. Weldability of Alloy PA2

Post-weld tensile test results of welded joint of alloy PA2 are as follows:

| S. No | UTS(ksi) | TYS(ksi) | Elong. (%) |
|---|---|---|---|
| PA2-LT1 | 50.2 | n.a. | 14.3 |
| PA2-LT2 | 50.5 | n.a. | 13.9 |

Post-weld tensile tests of welded joint of alloy PA2 show ductility of 14.3% and 13.9% elongation. Therefore, alloy PA2 is weldable.

2.E. Weldability of Alloy PA3 Post-weld tensile test results of welded joint of alloy PA3 are as follows

| alloy | UTS(ksi) | TYS(ksi) | Elong. (%) |
|---|---|---|---|
| PA3-LT1 | 54.1 | not avail. | 14.9 |
| PA3-LT2 | 51.7 | not avail. | 11.3 |

Post-weld tensile test of welded joint of alloy PA3 show ductility of 14.9% and 11.3% elongation. Therefore, alloy PA3 is weldable.

### 2.F. Weldability of Alloy PA4

Post-weld tensile test results of welded alloy PA4 are as follows:

| alloy | UTS(ksi) | TYS(ksi) | Elong. (%) |
|---|---|---|---|
| PA4-LT1 | 50.2 | not avail. | 13.9 |
| PA4-LT2 | 51.5 | not avail. | 16.2 |

Post-weld tensile tests of welded joint of alloy PA4 show ductility of 13.9% and 16.2% elongation. Therefore, alloy PA4 is weldable.

2.G. Weldability of Alloy PA5 Post-weld tensile test results of welded alloy PA5 are as follows:

| alloy | UTS(ksi) | TYS(ksi) | Elong. (%) |
|---|---|---|---|
| PA5-LT1 | 52.6 | not avail. | 13.7 |
| PA5-LT2 | 53.4 | not avail. | 14.5 |

Post-weld tensile tests of welded joint of alloy P43 show ductility of 13.7% and 14.5% elongation. Therefore, alloy PA5 is weldable.

This alloy contained misch metal and Cr instead of Cerium and Cr. Misch metal is an alloy containing cerium (Ce), lanthanum (La), neodymium (Nd) and other rare earth elements. This proves that Ce can be replaced with a combination of Cerium and other rare earth elements and show good weldability and SCC Resistance.

### 2.H. Weldability of Alloy PA6

Post-weld tensile test results of welded joint of alloy PA5 are as follows:

| alloy | UTS(ksi) | TYS(ksi) | Elong. (%) |
|---|---|---|---|
| PA6-LT1 | 54.8 | not avail. | 14.1 |
| PA6-LT2 | 55 | not avail. | 12.3 |

Post-weld tensile tests of welded joint of alloy PA6 show ductility of 14.1% and 12.3% elongation. Therefore, alloy PA6 is weldable.

### 2.I. Weldability of Alloy PA7

Post-weld tensile test results of welded joint of alloy PA7 are as follows:

| alloy | UTS(ksi) | TYS(ksi) | Elong. (%) |
|---|---|---|---|
| PA7-LT1 | 50.2 | not avail. | 11.8 |
| PA7-LT2 | 52.5 | not avail. | 13.6 |

Post-weld tensile test of welded joint of alloy PA7 show ductility of 11.8% and 13.6% elongation. Therefore, alloy PA7 is weldable.

### 2.J. Weldability of Alloy PA8

Post-weld tensile test results of welded joint of alloy PA8 are as follows:

| alloy | UTS(ksi) | TYS(ksi) | Elong. (%) |
|---|---|---|---|
| PA8-LT1 | 52.7 | not avail. | 12.3 |
| PA8-LT2 | 51.4 | not avail. | 11.9 |

Post-weld tensile test of welded joint of alloy PA8 show ductility of 12.3% and 11.9% elongation. Therefore, alloy PA8 is weldable.

2.K. Weldability of alloy PA9 Post-weld tensile test results of welded joint of alloy PA9 are as follows;

| alloy | UTS(ksi) | TYS(ksi) | Elong. (%) |
|---|---|---|---|
| PA9-LT1 | 52.6 | not avail. | 12.5 |
| PA9-LT2 | 53.1 | not avail. | 14.7 |

Post-weld tensile test of welded joint of alloy PA9 show ductility of 12.5% and 14.7% Elongation. Therefore, alloy PA9 is weldable.

### 3. Stress Corrosion Cracking Resistance (SCCR)

For plate gauge product, Stress Corrosion Cracking Resistance (SCCR) is a very important characteristic in determining engineering worthiness. Among the 11 alloys, 8 alloys are weldable. For the eight (8) weldability-proven alloys, SCCR tests were conducted on 38.1 mm plate at 26 ksi for 20 day tests per ASTM G-47. 26 ksi was selected because the most recently developed aluminum amor grade AA7085 is rated as SCCR at 26 ksi for 20 day test per G-47 as of December 1, 2020.

### 3.A. Stress Corrosion Cracking Test Results of Alloy PA2

SCCR tests of alloy PA2 (tested at 26 ksi for 20 day per G-47)

| sample | location | modulus | orientation | size (inch) | Stress(ksi) | Duration(days) | Pitting Rating | Disposition |
|---|---|---|---|---|---|---|---|---|
| SCC-1 | T/2 | 10.3 | ST | 0.125 | 26 | 11 | Light | Unacceptable |
| SCC-2 | T/2 | 10.3 | ST | 0.125 | 26 | 12 | Light-Moderate | Discontinue testing |
| SCC-3 | T/2 | 10.3 | ST | 0.125 | 26 | 6 | Light | Unacceptable |

All three samples have to pass 20 day test to be rated as “PASSED”.

Therefore, Alloy PA2 failed to pass SCCR test at 26 ksi for 20 day test period per G47.

### 3.B. Stress Corrosion Cracking Resistance Test Results of Alloy PA3

SCCR tests of alloy PA3 (tested at 26 ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 26 | 20 | Light | Acceptable |
| SCC-2 | T/2 | 10.3 | ST | 0.125 | 26 | 20 | Light | Acceptable |
| SCC-3 | T/2 | 10.3 | ST | 0.125 | 26 | 20 | Light | Acceptable |

All three samples have to pass 20 day test to be rated as “PASSED”.

Therefore, Alloy PA3 passed SCCR test at 26 ksi for 20 day test per G-47.

### 3.C. Stress Corrosion Cracking Resistance Test Results of Alloy PA4

SCCR tests of alloy PA4 (tested at 26ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 26 | 20 | Light | Acceptable |
| SCC-2 | T/2 | 10.3 | ST | 0.125 | 26 | 20 | Light | Acceptable |
| SCC-3 | T/2 | 10.3 | ST | 0.125 | 26 | 20 | Light | Acceptable |

All three samples passed 20 day test to be rated as “PASSED”

Therefore, Alloy PA4 passed SCCR test at 26 ksi for 20 day test per G-47.

### 3.D. Stress Corrosion Cracking Resistance Test Results of Alloy PA5

SCCR tests of alloy PA5 (tested at 26 ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 26 | 20 | Light | Acceptable |
| SCC-2 | T/2 | 10.3 | ST | 0.125 | 26 | 20 | Light | Acceptable |
| SCC-3 | T/2 | 10.3 | ST | 0.125 | 26 | 20 | Light | Acceptable |

All three samples passed at 26 ksi for 20 day test to be rated as “PASSED”.

Therefore, Alloy PA5 passed SCCR test at 26 ksi for 20 day test per G-47.

This alloy contained misch metal and Cr instead of Cerium and Cr. Misch metal is an alloy containing cerium (Ce), lanthanum (La), neodymium (Nd) and other rare earth elements. This proves that Ce can be replaced with combination of other rare earth elements and show good stress corrosion cracking resistance.

### 3.E. Stress Corrosion Cracking Resistance Test Results of Alloy PA6

SCCR tests of alloy PA6 (tested at 26 ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 26 | 20 | Light | Acceptable |
| SCC-2 | T/2 | 10.3 | ST | 0.125 | 26 | 20 | Light | Acceptable |
| SCC-3 | T/2 | 10.3 | ST | 0.125 | 26 | 20 | Light | Acceptable |

All three samples passed at 26 ksi for 20 day test to be rated as “PASSED”.

Therefore, Alloy PA6 passed SCCR test at 26 ksi for 20 day test per G-47.

There were some concerns that Stress Corrosion Cracking Resistance (SCCR) at 26 ksi stress level is too low of testing threshold stress level. Therefore, further tests were conducted at 30 ksi stress level.

### 3.F. Stress Corrosion Cracking Resistance Test Results of Alloy PA7

SCCR tests of alloy PA7 (tested at 30 ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 30 | 20 | Light | Acceptable |
| SCC-2 | T/2 | 10.3 | ST | 0.125 | 30 | 20 | Light | Acceptable |
| SCC-3 | T/2 | 10.3 | ST | 0.125 | 30 | 20 | Light | Acceptable |

All three samples passed 20 day test at 30 ksi stress level. The test results of alloy PA7 shows good Stress Corrosion Cracking Resistance (SCCR). However, alloy PA7 is containing 0.15 wt. % of Ce. The price of Ce is expensive. Therefore, containing 0.15 wt. % Ce as an alloying element makes the alloy expensive. A better solution is desirable.

### 3.G. Stress Corrosion Cracking Resistance Test Results of Alloy PA8

As an attempt to reduce the price of the alloy without losing SCCR property, 0.15 wt. % of Ce is replaced with 0.075 wt. % of Ce and 0.075 wt. % of Cr. The price of Cr is not expensive.

SCCR tests of alloy PA8 (tested at 30 ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 30 | 20 | Light | Acceptable |
| SCC-2 | T/2 | 10.3 | ST | 0.125 | 30 | 20 | Light | Acceptable |
| SCC-3 | T/2 | 10.3 | ST | 0.125 | 30 | 20 | Light | Acceptable |

Alloy PA8 passed SCCR test at 30 ksi for 20 day test per G-47

### 3.H. Stress Corrosion Cracking Resistance Test Results of Alloy PA9

In order to reduce the price of the alloy further, 0.075 wt. % Ce and 0.075 wt. % Cr were replaced with 0.05 wt. % Ce and 0.05 wt. % Cr in Alloy PA9.

SCCR tests of alloy PA9 (tested at 30 ksi for 20 day per G-47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 30 | 20 | Light | Acceptable |
| SCC-2 | T/2 | 10.3 | ST | 0.125 | 30 | 20 | Light | Acceptable |
| SCC-3 | T/2 | 10.3 | ST | 0.125 | 30 | 20 | Light | Acceptable |

Alloy PA9 passed SCCR test at 30 ksi for 20 day test per G-47.

Among the seven alloys tested for weldability and Stress Corrosion Cracking Resistance (SCCR), only seven alloys, namely alloy PA3, alloy PA4, alloy PA5, alloy PA6, alloy PA7, alloy PA8 and alloy PA9, showed acceptable weldability and Stress Corrosion Cracking Resistance. Only these seven alloys will be tested for mechanical properties.

### 4. Mechanical Properties of 3.81 cm Thick Plate

Mechanical properties of 3.81 cm thick plate are tested on seven alloys with acceptable SCCR: alloy PA3, alloy PA4, alloy PA5, alloy PA6, alloy PA7, alloy PA8 and alloy PA9.

### 4.A. Mechanical Property of Alloy PA3

Duplicate tensile tests per ASTM B557-15 (as of Dec. 1, 2020) are conducted on 3.81 cm plate of PA3 alloy. The test direction was in long transverse (LT) direction. The Ultimate Strength (UTS), Tensile Yield Stress (TYS) and Elongation (Elong.) are as follows:

| alloy | direction | UTS(ksi) | TYS(ksi) | Elong. (%) |
|---|---|---|---|---|
| alloy PA3 | LT1 | 69.5 | 64.6 | 4.1 |
| alloy PA3 | LT2 | 66 | 61.4 | 4.4 |

### 4.B. Mechanical Property of Alloy PA4

Duplicate tensile tests are conducted on 3.81 cm Plate of alloy PA4 in LT direction. The test results are as follows:

| alloy | direction | UTS(ksi) | TYS(ksi) | Elong. (%) |
|---|---|---|---|---|
| alloy PA4 | LT1 | 70.8 | 65.6 | 5 |
| alloy PA4 | LT2 | 77.8 | 66.2 | 5.5 |

### 4.C. Mechanical Property of Alloy PA5

Duplicate tensile tests are conducted on 3.81 cm Plate of alloy PA5 in LT direction. The test results are as follows:

| alloy | direction | UTS(ksi) | TYS(ksi) | Elong. (%) |
|---|---|---|---|---|
| alloy PA5 | LT1 | 70.9 | 64.9 | 12 |
| alloy PA5 | LT2 | 71 | 64.7 | 10 |

### 4.D. Mechanical Property of Alloy PA6

Duplicate tensile tests are conducted on 3.81 cm Plate of alloy PA6 in LT direction. The test results are as follows:

| alloy | direction | UTS(ksi) | TYS(ksi) | Elong. (%) |
|---|---|---|---|---|
| alloy PA6 | LT1 | 75.3 | 70.2 | 10 |
| alloy PA6 | LT2 | 76.4 | 71.2 | 10 |

### 4.E. Mechanical Property of Alloy PA7

Duplicate tensile tests are conducted on 3.81 cm Plate of PA7 alloy. The test direction was in Long Transverse direction (LT direction). The ultimate tensile strength (UTS), tensile yield stress (TYS) and elongation (Elong.) are as follows:

| alloy | direction | UTS(ksi) | TYS(ksi) | Elong. (%) |
|---|---|---|---|---|
| alloy PA7 | LT1 | 75.1 | 69.4 | 10 |
| alloy PA7 | LT2 | 75.6 | 70 | 10 |

The test results of alloy PA7 show good tensile properties.

### 4.F. Mechanical Property of Alloy PA8

Duplicate tensile tests are conducted on 3.81 cm Plate of PA8 alloy in LT direction. The test results are as follows:

| alloy | direction | UTS(ksi) | TYS(ksi) | Elong. (%) |
|---|---|---|---|---|
| alloy PA8 | LT1 | 76.3 | 70.3 | 11.5 |
| alloy PA8 | LT2 | 78.1 | 72.3 | 9 |

The test results of alloy PA8 show good tensile properties.

### 4.G. Mechanical Property of Alloy PA9

Duplicate tensile tests are conducted on 3.81 cm Plate of PA9 alloy in LT direction. The test results are as follows:

| alloy | direction | UTS(ksi) | TYS(ksi) | Elong. (%) |
|---|---|---|---|---|
| alloy PA9 | LT1 | 76.9 | 71.4 | 11.5 |
| alloy PA9 | LT2 | 76.6 | 70.9 | 9.5 |

The test results of alloy PA9 show good tensile properties.

### 5. The Summary of the Test Results of the Most Preferred Embodiment of Invented Alloy PA9

### 5.A. Chemistry of Alloy PA9:

| alloy | Cu | Mg | Mn | Ti | Zr | Zn | Cr | Ce | Ni |
|---|---|---|---|---|---|---|---|---|---|
| alloy PA9 | 0 | 2.3 | 0.3 | 0.12 | 0.12 | 6.3 | 0.05 | 0.05 | 0 |

Remainders are aluminum and impurities such as Fe and Si and others.

### 5.B. Post-Weld Tensile Property of Alloy PA9:

| alloy | UTS(ksi) | TYS(ksi) | Elong. (%) |
|---|---|---|---|
| PA9-LT1 | 52.6 | not avail. | 12.5 |
| PA9-LT2 | 53.1 | not avail. | 14.7 |

### 5.C. Stress Corrosion Cracking Resistance of Alloy PA9 (Tested at 30 Ksi for 20 Day Test Per G47)

| sample | location | modulus | orientation | size(inch) | Stress(ksi) | Duration(days) | Pitting Rating | Disposition |
|---|---|---|---|---|---|---|---|---|
| SCC-1 | T/2 | 10.3 | ST | 0.125 | 30 | 20 | Light | Acceptable |
| SCC-2 | T/2 | 10.3 | ST | 0.125 | 30 | 20 | Light | Acceptable |
| SCC-3 | T/2 | 10.3 | ST | 0.125 | 30 | 20 | Light | Acceptable |

### 5.D. Mechanical Properties of Alloy PA9:

| alloy | direction | UTS(ksi) | TYS(ksi) | Elong. (%) |
|---|---|---|---|---|
| alloy PA9 | LT1 | 76.9 | 71.4 | 11.5 |
| alloy PA9 | LT2 | 76.6 | 70.9 | 9.5 |

The disclosure may be considered to relate to the following items:

1. A 7xxx aluminum alloy, comprising:
4.0-8.0 wt. % zinc;
1.5-3.0 wt. % magnesium;
0.01-0.8 wt. % of a material selected from a group consisting of a rare earth element, cerium, misch metal, lanthanum, neodymium, samarium or combinations thereof;
dispersoid forming elements selected from a group consisting of up to 1.2 wt. % manganese, between 0.01-0.25 wt. % titanium and 0.01-0.11 wt. % of boron as a form of titanium diboride (titanium diboride intermetallic particle), up to 1.0 wt. % of zirconium, up to 1.0 wt. % of chromium, and combinations thereof; up to 1.0 wt. % impurities; and remainder as aluminum.

2. The 7xxx aluminum alloy of item 1, wherein the impurities include up to 0.5 wt. % iron.

3. The 7xxx aluminum alloy of item 1, wherein the impurities include up to 0.5 wt. % silicon.

4. The 7xxx aluminum alloy of item 1, wherein the impurities include less than 0.3 wt. % copper.

5. The 7xxx aluminum alloy of item 1, wherein the impurities include less than 0.1 wt. % copper.

6. The 7xxx aluminum alloy of item 1 is free of copper.

7. The 7xxx aluminum alloy of item 1, wherein the rare earth element is selected from a group consisting of yttrium, praseodymium, promethium, gadolinium, terbium, dysprosium, holmium, erbium, thulium, ytterbium, lutetium and combinations thereof.

8. The 7xxx aluminum alloy of any of items 1-7, including less than 0.8 wt. % scandium.

9. The 7xxx aluminum alloy of any of items 1-7, including less than 0.3 wt. % scandium.

10. The 7xxx aluminum alloy of any of items 1-7, wherein said 7xxx aluminum alloy is free of scandium.

11. The 7xxx aluminum alloy of any of items 1-10, including less than 0.8 wt. % nickel.

12. The 7xxx aluminum alloy of any of items 1-10, including less than 0.3 wt. % nickel.

13. The 7xxx aluminum alloy of any of items 1-10, wherein said 7xxx aluminum alloy is free of nickel.

14. The 7xxx aluminum alloy of any of items 1-13, including less than 0.25 wt. % vanadium.

15. The 7xxx aluminum alloy of any of items 1-13, including less than 0.15 wt. % vanadium.

16. The 7xxx aluminum alloy of any of items 1-13, wherein said 7xxx aluminum alloy is free of vanadium.

17. The 7xxx aluminum alloy of claim 1, wherein the magnesium is between 2.1 and 3.0 weight %.

18. The 7xxx aluminum alloy of item 1, wherein the magnesium is between 2.5 and 3.0 wt. %.

19. The 7xxx aluminum alloy of item 1, wherein the titanium content is between 0.16 and 0.25 wt. %.

20. The 7xxx aluminum alloy of item 1, wherein the titanium content is between 0.20 and 0.25 wt. %.

21. The 7xxx aluminum alloy of any of item 1, wherein the zirconium content is between 0.21 and 0.23 wt. %.

22. The 7xxx aluminum alloy of any of items 1, wherein the zirconium content is about 0.23 wt. %.

23. A 7xxx aluminum alloy, consisting of:
5.0-7.5 wt. % zinc;
1.5-2.6 wt. % magnesium;
0.01-1.0 wt. % manganese;
0.01-0.3 wt. % of a material selected from a group consisting of rare earth elements, cerium, misch metal, lanthanum, neodymium, samarium or combinations thereof;
0.01-0.25 wt. % titanium;
0.01-0.11 wt. % of boron as a form of titanium diboride intermetallic particles;
up to 0.3 wt. % zirconium;
up to 1 wt. % impurities; and
remainder as aluminum.

24. The 7xxx aluminum alloy of item 23, wherein the rare earth element is selected from a group consisting of yttrium, praseodymium, promethium, gadolinium, terbium, dysprosium, holmium, erbium, thulium, ytterbium, lutetium and combinations thereof.

25. The 7xxx aluminum alloy of item 23 or item 24, further including up to 1.0 wt. % chromium.

26. The 7xxx aluminum alloy of items 23-25, having 0.1-0.5 wt. % manganese.

27. The 7xxx aluminum alloy of items 23-25, wherein the impurities include less than 0.3 wt. % copper.

28. The 7xxx aluminum alloy of items 23-25, wherein the impurities include less than 0.1 wt. % copper.

29. The 7xxx aluminum alloy of items 23-25, wherein the 7xxx aluminum alloy is free of copper.

30. The 7xxx aluminum alloy aluminum alloy of items 23-25, including less than 0.8 wt. % scandium.

31. The 7xxx aluminum alloy of any of items 23-25, including less than 0.3 wt. % scandium.

32. The 7xxx aluminum alloy of any of items 23-25, wherein the 7xxx aluminum alloy is free of scandium.

33. The 7xxx aluminum alloy of any of items 23-25, including less than 0.8 wt. % nickel.

34. The 7xxx aluminum alloy of any of items 23-25, including less than 0.3 wt. % nickel.

35. The 7xxx aluminum alloy of any of items 23-25, wherein the 7xxx aluminum alloy is free of nickel.

36. The 7xxx aluminum alloy of any of items 23-25, including less than 0.25 wt. % vanadium.

37. The 7xxx aluminum alloy of any of items 23-25, including less than 0.15 wt. % vanadium.

38. The 7xxx aluminum alloy of any of items 23-25, wherein the 7xxx aluminum alloy is free of vanadium.

39. The 7xxx aluminum alloy of item 23, wherein the 7xxx aluminum alloy has a post weld ductility of at least 3.0% elongation across a weldment.

40. The 7xxx aluminum alloy system of item 39, wherein the 7xxx alloy has an ultimate strength of at least 65 ksi in long transverse direction before welding.

41. The 7xxx aluminum alloy of item 40, wherein the 7xxx alloy has a tensile yield strength of at least 60 ksi in the long transverse direction before welding.

42. The 7xxx aluminum alloy of item 41, wherein the 7xxx alloy has an elongation of at least 4% in the long transverse direction before welding.

43. The 7xxx alloy of item 23, wherein the 7xxx alloy has a stress corrosion cracking resistance of at least 26 ksi in short transverse direction before welding for 20 days per G47 as of Dec. 1, 2020.

44. The 7xxx aluminum alloy of item 23, wherein the 7xxx alloy has an ultimate strength of at least 65 ksi in the long transverse direction before welding.

45. The 7xxx aluminum alloy of item 23, wherein the 7xxx alloy has a tensile yield strength of at least 60 ksi in the long transverse direction before welding.

46. The 7xxx aluminum alloy system of item 23, wherein the 7xxx alloy has an elongation of at least 4% in the long transverse direction before welding.

47. The 7xxx aluminum alloy of item 23, wherein the magnesium is between 2.1 and 3.0 wt. %.

48. The 7xxx aluminum alloy of item 23, wherein the magnesium is between 2.5 and 3.0 wt. %.

49. The 7xxx aluminum alloy of item 23, wherein the titanium content is between 0.16 and 0.25 wt. %.

50. The 7xxx aluminum alloy of item 23, wherein the titanium content is between 0.20 and 0.25 wt. %.

51. The 7xxx aluminum alloy of item 23, wherein the zirconium content is between 0.21 and 0.23 wt. %.

52. The 7xxx aluminum alloy of item 23, wherein the zirconium content is about 0.23 wt. %.

53. A welding wire alloy, comprising:
3.0-4.5 wt. % zinc;
1.5-5.0 wt. % magnesium;
0.01-0.8 wt. % of a material selected from a group consisting of (a) a rare earth element, cerium, misch metal, lanthanum, neodymium, samarium, or combinations thereof, (b) a dispersoid forming element selected from a group consisting of up to 1.2 wt. % manganese, between 0.01-0.25 wt. % titanium, between 0.01-0.2 wt. % boron, up to 1.0 wt. % of zirconium, up to 1.0 wt. % of chromium, and combinations thereof;
up to 1 wt. % of impurities including less than 0.1 wt. % copper; and
remainder as aluminum.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of”. Each of the phrases “consisting of” and “consists of”, as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic being a system, unit system, sub-unit device, assembly, sub-assembly, mechanism, structure, component or element or, peripheral equipment utility, accessory, or material, step or procedure, sub-step or sub-procedure, but only if each such additional feature or characteristic does not materially alter the basic novel and inventive characteristics or special technical features, of the claimed item.

Terms of approximation, such as the terms about, substantially, approximately, etc., as used herein, refers to ±10% of the stated numerical value.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1-22. (canceled)

23. A 7xxx aluminum alloy, comprising:
5.0-7.5 wt. % zinc;
1.5-2.6 wt. % magnesium;
0.01-1.0 wt. % manganese;
0.01-0.3 wt. % of a material selected from a group consisting of a rare earth element, cerium, misch metal, lanthanum, neodymium, samarium or combinations thereof;
0.01-0.25 wt. % titanium and 0.01-0.11 wt. % of boron as a form of titanium diboride;
up to 0.3 wt. % zirconium;
up to 1 wt. % impurities; and
remainder as aluminum.

24. The 7xxx aluminum alloy of claim 23, wherein the rare earth element is selected from a group consisting of yttrium, praseodymium, promethium, gadolinium, terbium, dysprosium, holmium, erbium, thulium, ytterbium, lutetium and combinations thereof.

25. (canceled)

26. The 7xxx aluminum alloy of claim 23, having 0.1-0.5 wt. % manganese.

27. The 7xxx aluminum alloy of claim 23, wherein the impurities include less than 0.3 wt. % copper.

28. The 7xxx aluminum alloy of claim 23, wherein the impurities include less than 0.1 wt. % copper.

29. The 7xxx aluminum alloy of claim 23, wherein the 7xxx aluminum alloy is free of copper.

30. The 7xxx aluminum alloy of claim 23, including less than 0.8 wt. % scandium.

31. The 7xxx aluminum alloy of claim 23, including less than 0.3 wt. % scandium.

32. The 7xxx aluminum alloy of claim 23, wherein the 7xxx aluminum alloy is free of scandium.

33. (canceled)

34. (canceled)

35. (canceled)

36. (canceled)

37. The 7xxx aluminum alloy of claim 23, including less than 0.15 wt. % vanadium.

38. (canceled)

39. The 7xxx aluminum alloy of claim 23, wherein the 7xxx aluminum alloy has a post weld ductility of at least 3.0% elongation across a weldment.

40. The 7xxx aluminum alloy of claim 39, wherein the 7xxx alloy has an ultimate strength of at least 65 ksi in long transverse direction before welding.

41. The 7xxx aluminum alloy of claim 40, wherein the 7xxx alloy has a tensile yield strength of at least 60 ksi in the long transverse direction before welding.

42. The 7xxx aluminum alloy of claim 41, wherein the 7xxx alloy has an elongation of at least 4% in the long transverse direction before welding.

43. The 7xxx alloy of claim 23, wherein the 7xxx alloy has a stress corrosion cracking resistance of at least 26 ksi in short transverse direction before welding for 20 days per G47 as of Dec. 1, 2020.

44. The 7xxx aluminum alloy of claim 23, wherein the 7xxx alloy has an ultimate strength of at least 65 ksi in the long transverse direction before welding.

45. The 7xxx aluminum alloy of claim 23, wherein the 7xxx alloy has a tensile yield strength of at least 60 ksi in the long transverse direction before welding.

46. The 7xxx aluminum alloy system of claim 23, wherein the 7xxx alloy has an elongation of at least 4% in the long transverse direction before welding.

47. The 7xxx aluminum alloy of claim 23, wherein the magnesium is between 2.1 and 3.0 wt. %.

48. The 7xxx aluminum alloy of claim 23, wherein the magnesium is between 2.5 and 3.0 wt. %.

49-53. (canceled)
